(19) United States
(12) Patent Application Publication
(10) Pub. No.: US 2021/0105516 A1
(43) Pub. Date: Apr. 8, 2021

(54) METHOD TO CREATE A LIVE VIDEO STREAM FROM SHARED MEMORY OBJECT CONTAINING IMAGE BUFFER

(71) Applicant: Honeywell International Inc., Morris Plains, NJ (US)

(72) Inventors: Shreyas JOSHI, Bangalore (IN); Pankaj Kumar GUPTA, Bangalore (IN); Snehal Vilas KESKAR, Bangalore (IN)

(21) Appl. No.: 16/594,682

(22) Filed: Oct. 7, 2019

(51) Int. Cl. H04N 21/2343; H04N 21/2187; H04N 21/2347

(52) U.S. Cl. CPC H04N 21/23439; H04N 21/2347; H04N 21/2187

(57) ABSTRACT

A method, apparatus, and computer program product provide for generating a video stream from a shared memory object containing image data from an image buffer. In the context of a method, the method generates a shared memory object from an image buffer comprising image data associated with a first iteration of two or more iterations of a graphics application, wherein the image data comprises data from at least one pixel related to the first iteration. The method generates converted image data based on a conversion of the pixel data in a first data format to converted image data in a second data format and generates an image file comprising the converted image data for the first iteration. The method also outputs the image file for the first iteration to a user device in conjunction with at least another image file from another iteration of the two or more iterations to provide a video stream of the two or more iterations.

### TECHNOLOGICAL FIELD

An example embodiment relates generally to video streaming, and, more particularly, to techniques for generating a video stream based on data in an image buffer.

### BACKGROUND

In some examples, video streaming over a network connection continues to grow more popular as a form of media consumption. This process typically requires a form of source media (e.g., an internet protocol camera such as a webcam), an encoder to digitize the content, a media publisher, and a content delivery network to distribute and deliver the content. Though popular, live video streaming continues to face challenges including latency, buffering issues, and incompatibility with certain end-user devices.

Current methods for video streaming exhibit a plurality of problems that make current systems insufficient, ineffective and/or the like. Through applied effort, ingenuity, and innovation, solutions to improve such methods have been realized and are described in connection with embodiments of the present invention.

### BRIEF SUMMARY

A method, apparatus, and computer program product are disclosed for generating a video stream from a shared memory object containing image data from an image buffer. In this regard, the method, apparatus and computer program product are configured to generate a shared memory object from an image buffer comprising image data associated with a first iteration of two or more iterations of a graphics application, generate an image file comprising converted image data for the first iteration, and output the image file for the first iteration to a user device in conjunction with at least another iteration of the two or more iterations to provide a stream of the two or more iterations. By utilizing an image buffer as an input source and iteratively updating the shared memory object based on iterative updates to the image buffer by the graphics application, a lighter, faster, and more secure approach to live video streaming is provided compared to traditional streaming methods. Benefits of this design include streaming and updating the video stream in or near real-time.

In an example embodiment, a computer-implemented method is provided for generating a video stream. The computer-implemented method comprises generating a shared memory object from an image buffer comprising image data associated with a first iteration of two or more iterations of a graphics application, wherein the image data comprises pixel data from at least one pixel related to the first iteration. The computer-implemented method further comprises generating converted image data based on a conversion of the pixel data in a first data format to converted image data in a second data format. The computer-implemented method further comprises generating an image file comprising the converted image data for the first iteration. The computer-implemented method also comprises outputting the image file for the first iteration to a user device in conjunction with at least another image file from another iteration of the two or more iterations to provide a video stream of the two or more iterations.

In some embodiments, the computer-implemented method further comprises updating the shared memory object in an instance in which the image buffer comprises image data associated with a second iteration, wherein the shared memory object comprises the image data associated with the second iteration. In some embodiments, the computer-implemented method further comprises generating converted image data for the second iteration. In some embodiments, the computer-implemented method further comprises generating an image file comprising the converted image data for the second iteration, wherein the second image file overwrites the image file comprising converted image data for the first iteration. In some example embodiments, the computer-implemented method further comprises outputting the second image file to a user device in conjunction with the first iteration. In an embodiment, generating the shared memory object from the image buffer comprises determining a width value and a height value associated with the image data of the first iteration, determining an x-coordinate and a y-coordinate to identify a location of at least one pixel within the image data, determining a data format and a data type of the at least one pixel associated with the image data, and, based at least on the width value, height value, and location, reading at least one pixel associated with the image data and writing the at least one pixel to the shared memory object in accordance with the data format and the data type.

In some embodiments, generating the image file comprising the converted image data for the first iteration comprises determining a location and a first data format of the at least one pixel of the shared memory object and writing the at least one pixel in the second data format to the image file in accordance with the location. In certain embodiments, the image data is updated in the image buffer by the graphics application. In some embodiments, providing a video stream of the two or more iterations comprises encoding the video stream in a predefined format and encrypting the video stream in a predefined format.

In a further example embodiment, a computer program product is provided that comprises a non-transitory computer readable storage medium having program code portions stored thereon with the program code portions configured, upon execution, to generate a shared memory object from an image buffer comprising image data associated with a first iteration of two or more iterations of a graphics application, wherein the image data comprises data from at least one pixel related to the first iteration. The program code portions are further configured, upon execution, to generate converted image data based on a conversion of the pixel data in a first data format to converted image data in a second data format. The program code portions are further configured, upon execution, to generate an image file comprising the converted image data for the first iteration. The program code portions are further configured, upon execution, to output the image file for the first iteration to a user device in conjunction with at least another image file from another iteration of the two or more iterations to provide a video stream of the two or more iterations.

In some embodiments, the program code portions are further configured, upon execution, to update the shared memory object in an instance in which the image buffer comprises image data associated with a second iteration, wherein the shared memory object comprises the image data associated with the second iteration. In some embodiments, the program code portions are further configured, upon execution, to generate converted image data for the second iteration. In some embodiments, the program code portions are further configured, upon execution, to generate an image file comprising converted image data for the second iteration based on converted image data for the second iteration, wherein the second image file overwrites the image file comprising converted image data for the first iteration. In some embodiments, the program code portions are further configured, upon execution, to output the second image file to a user device in conjunction with the first iteration. In an embodiment, the computer-readable program code portions comprising an executable portion configured to generate the shared memory object from the image buffer is further configured to determine a width value and a height value associated with the image data of the first iteration, determine an x-coordinate and a y-coordinate to identify a location of at least one pixel associated with the image data, determining a data format and a data type of the at least one pixel associated with the image data, and, based at least on the width value, height value, and location, reading at least one pixel associated with the image data and write the at least one pixel to the shared memory object in accordance with the data format and the data type.

In some embodiments, the computer-readable program code portions comprising an executable portion configured to generate the image file comprising converted image data for the first iteration is further configured to determine a location and a first data format of the at least one pixel of the shared memory object and write the at least one pixel in the second data format to the image file in accordance with the location. In certain embodiments, the computer-readable program code portions comprising the executable portion are further configured to at least update the image data in the image buffer by the graphics application. In some embodiments, the computer-readable program code portions comprising an executable portion configured to provide a video stream of the two or more iterations is further configured to encode the video stream in a predefined format and encrypt the video stream in a predefined format.

In a further example embodiment, an apparatus configured to generate a video stream is provided comprising at least one processor; and at least one memory including computer program code configured to, with the at least one processor, cause the apparatus to at least generate a shared memory object from an image buffer comprising image data associated with a first iteration of two or more iterations of a graphics application wherein the image data comprises pixel data from at least one pixel related to the first iteration. The apparatus is further configured to generate converted image data based on a conversion of the pixel data in a first data format to converted image data in a second data format. The apparatus is further configured to generate an image file comprising the converted image data for the first iteration. The apparatus is further configured to output the image file for the first iteration to a user device in conjunction with at least another image file from another iteration of the two or more iterations to provide a video stream of the two or more iterations.

In some embodiments, the apparatus is further be configured to update the image data of the shared memory object in an instance in which the image buffer comprises image data associated with a second iteration, wherein the shared memory object comprises the image data associated with the second iteration. In some embodiments, the apparatus is further configured to generate converted image data for the second iteration. In some embodiments, the apparatus is further configured to generate an image file comprising the converted image data for the second iteration, wherein the second image file overwrites the image file comprising converted image data for the first iteration. In some embodiments, the apparatus is further configured to output the second image file to a user device in conjunction with the first iteration. In an embodiment, the at least one non-transitory memory and the program code that is configured to, with the processor, cause the apparatus to at least generate the shared memory object from the image buffer is further configured to determine a width value and a height value associated with the image data of the first iteration, determine an x-coordinate and a y-coordinate to identify a location of at least one pixel associated with the image data, determine a data format and a data type of the at least one pixel associated with the image data, and, based at least on the width value, height value, and location, read at least one pixel associated with the image data and write the at least one pixel to the shared memory object in accordance with the data format and the data type.

In some embodiments, the at least one non-transitory memory and the program code that is configured to, with the processor, cause the apparatus to at least generate the image file comprising the converted image data is further configured to determine a location and a first data format of the at least one pixel of the shared memory object, and write the at least one pixel in the second data format to the image file in accordance with the location. In certain embodiments, the at least one non-transitory memory and the program code is further configured to, with the processor, cause the apparatus to at least update the image data in the image buffer by the graphics application. In some embodiments, the at least one non-transitory memory and the program code that is configured to, with the processor, cause the apparatus to at least provide a video stream of the two or more iterations is further configured to encode the video stream in a predefined format and encrypt the video stream in a predefined format.

### BRIEF DESCRIPTION OF THE DRAWINGS

Having thus described certain example embodiments of the present disclosure in general terms, reference will hereinafter be made to the accompanying drawings, which are not necessarily drawn to scale, and wherein:

FIG. 1 is a block diagram of a system configured to communicate via a network in accordance with an example embodiment;

FIG. 2 is a block diagram of an apparatus that may be specifically configured in accordance with an example embodiment of the present disclosure; and

FIGS. 3A-3C are flowcharts illustrating operations performed in accordance with an example embodiment.

### DETAILED DESCRIPTION

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device (such as a core network apparatus), field programmable gate array, and/or other computing device.

In some examples, applications and simulations provide an output related to the performance of a particular task or the performance of a particular simulation. In some examples, the output could take the form of an image or could take the form of data representative of an image (e.g., pixel data). In further examples, such applications or simulations may generate an output in the form of log files or output files in the form of diagrams, images, or the like. For example, a mapping application may generate a series of outputs representative of map locations, simulation data, or the like. In other examples, such as an application related to pilot training, an application may output instrument readings at a given time or performance at a given time.

By way of further example, pilot training services typically include applications for simulating flight operations. For example, the avionics of an aircraft may be simulated via software at a computing device in order to prepare a pilot-in-training for various scenarios and encounters prior to piloting an actual aircraft. The simulated avionics may include simulations of communications, navigation, the display and management of multiple controls, and/or the multitude of systems that are fitted to aircraft to perform individual functions. Additionally, software simulations of avionics may be used for development and testing of aircraft displays, flight management and control systems, and/or the like.

Certain example avionics simulations may comprise components of actual aircraft software and allow for re-creation of at least a portion of aircraft displays when provided with Avionics Standard Communication Bus (ASCB) parameters. For example, one such example use case may be to re-create at least a portion of aircraft synoptic pages. An example aircraft synoptic page typically provides image data that provides a broad overview of various systems and conditions at a point in time during plane operation and/or flight, such as by including or otherwise representing diagrams of one or more components of the aircraft and/or related data, such as recorded temperatures, speed readings, and/or the like. Data associated with aircraft synoptic pages of a particular flight may be read, in some examples, from one or more Aircraft Condition Monitoring Function (ACMF) log files as raw data after the simulation flight has concluded. However, this raw data may be difficult to interpret by a maintenance engineer and/or student without being visually organized into an image, such as an aircraft synoptic page or related diagram.

In one exemplary embodiment, current solutions may be configured to recreate synoptic page data as images and generate a video from the images once a simulation comprising data, such as example ACMF log files, has ended. In such examples, the exemplary video may then be provided to a user for playback. However, in this scenario, the user is forced to wait until the simulation is over and the video is separately generated, such that this method would fail to provide the user with the stream in real-time. Other methods, such as by communicating the images under Real Time Streaming Protocol (RTSP) over the internet via User Datagram Protocol (UDP) or Transmission Control Protocol (TCP), may require additional port openings or changes in aspects of the provider's firewall, leaving the provider vulnerable to penetration attacks. Further, re-streaming the RTSP stream into a Hypertext Transfer Protocol (HTTP) live stream or Moving Pictures Experts Group-Dynamic Adaptive Streaming over HTTP (MPEG-DASH) stream adds unwanted latency and time delay. As such, exemplary systems are not designed to provide a video stream, motion pictures, a series of images or the like in real time or semi-real time during the run time of the application and/or the simulation.

Example systems and methods disclosed herein allow for the generation of a video stream comprised of two or more images generated from image data stored by one or more applications and/or simulations. In some examples, the image data stored is based on an input to the application and/or simulation, such as a data file, log file or the like. Advantageously, in some examples, the images are generated in real-time or semi-real time during the run time of the application and/or simulation. In such cases, the systems and methods described herein are configured to convert image data associated with the output file, log file, or the like to image files that can be converted and then played or otherwise displayed with a series of other image files to generate a video stream.

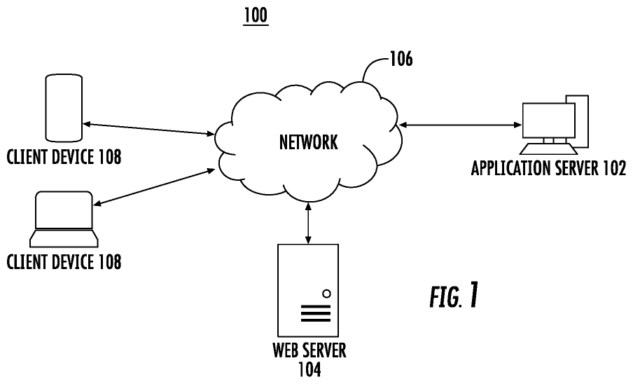

Referring now to FIG. 1, FIG. 1 illustrates a block diagram of a system 100 for generating a video stream from a shared memory object containing image data from an image buffer, according to an example embodiment. It will be appreciated that the system 100 as well as the illustrations in other figures are each provided as an example of some embodiments and should not be construed to narrow the scope or spirit of the disclosure in any way. In this regard, the scope of the disclosure encompasses many potential embodiments in addition to those illustrated and described herein. As such, while FIG. 1 illustrates one example of a configuration of a system for generating a video stream from a shared memory object containing image data from an image buffer, numerous other configurations may also be employed.

The system 100 may include one or more application servers 102, web servers 104, one or more client devices 108 (also known as user devices) and a network 106. The one or more application servers 102 may take the form of computer hardware and/or software that is configured to provide a service, such as generating a video stream from a shared memory object that is generated based on image data from an iteration of an application that is stored in an image buffer. In some embodiments, the one or more application servers 102 may include, without limitation, personal computers, enterprise computers, cloud-based platforms, enterprise servers, desktop computers, and the like. According to some embodiments, the application server 102 may comprise one or more software applications, such as a graphics application, simulation software application, and/or the like.

According to various embodiments, one or more application servers 102 may be configured to connect directly with one or more web servers 104 and/or client devices 108 via, for example, an air interface without routing communications via one or more elements of the network 106. Alternatively, or additionally, one or more of the application servers 102 may be configured to communicate with one or more of the web servers 104 and/or client devices 108 over the network 106. In this regard, the one or more application servers 102 may communicate one or more image files associated with a video stream to one or more client devices 108 via the network 106. In some examples, the one or more client devices 108 may be configured to access or otherwise view the video stream.

The network 106 may comprise one or more wireline networks, one or more wireless networks, or some combination thereof. The network 106 may, for example, comprise a serving network (e.g., a serving cellular network) for one or more client devices 108. The network 106 may comprise, in certain embodiments, one or more application servers 102, web servers 104, and/or one or more client devices 108. According to example embodiments, the network 106 may comprise the Internet, an intranet, and/or the like.

In various embodiments, the network 106 may comprise a wired access link connecting one or more application servers 102 to the rest of the network 106 using, for example, Digital Subscriber Line (DSL) technology. In some embodiments, the network 106 may comprise a public land mobile network (for example, a cellular network), such as may be implemented by a network operator (for example, a cellular access provider). The network 106 may operate in accordance with universal terrestrial radio access network (UTRAN) standards, evolved UTRAN (E-UTRAN) standards, current and future implementations of Third Generation Partnership Project (3GPP) LTE (also referred to as LTE-A) standards, current and future implementations of International Telecommunications Union (ITU) International Mobile Telecommunications Advanced (IMT-A) systems standards, and/or the like. It will be appreciated, however, that where references herein are made to a network standard and/or terminology particular to a network standard, the references are provided merely by way of example and not by way of limitation.

The web server 104 may comprise computer hardware and/or software that is configured to store, process, and deliver web content to client devices 108. In some embodiments, the one or more web servers 104 may include, without limitation, personal computers, enterprise computers, enterprise servers, mainframe servers, desktop computers, and the like. In some embodiments, the web server 104 may be configured to receive a video stream comprising a plurality of image files from an application server 102 and host and/or restream the video stream to a client device 108. In this regard, the web server 104 may be configured to generate a playable uniform resource locator (URL) and provide the playable URL to a client device 108.

The client devices 108 may take the form of computer hardware and/or software that is configured to access a service, such as a video stream, made available by a server. The server is often (but not always) on another computer system, in which case the client device accesses the service by way of a network. Client devices may include, without limitation, smart phones, tablet computers, laptop computers, wearables, personal computers, enterprise computers, desktop computers, and the like. In the avionics simulation example described above, a client device 108 may be associated with (e.g., belong to) a maintenance engineer, such that the maintenance engineer may view a video stream generated by the application server 102 on the client device. In one embodiment, the client device 108 may be associated with a pilot-in-training or other type of student, such that the student may access and view a video stream for training and/or testing purposes.

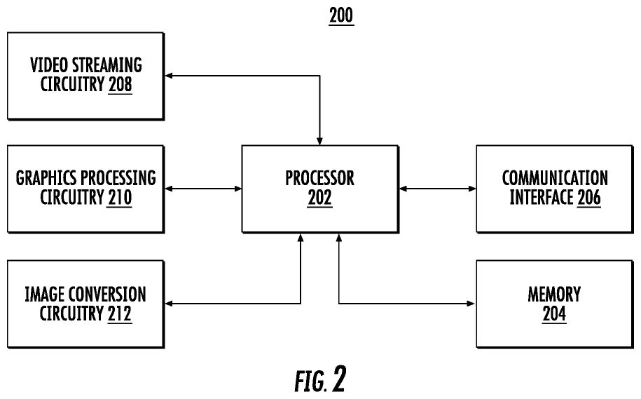

One example of an apparatus 200 that may be configured to function as the application server 102 and/or web server 104 is depicted in FIG. 2. As shown in FIG. 2, the apparatus includes, is associated with or is in communication with processing circuitry 202, a memory 204 and a communication interface 206. The processing circuitry 202 may be in communication with the memory device via a bus for passing information among components of the apparatus. The memory device may be non-transitory and may include, for example, one or more volatile and/or non-volatile memories. In other words, for example, the memory device may be an electronic storage device (e.g., a computer readable storage medium) comprising gates configured to store data (e.g., bits) that may be retrievable by a machine (e.g., a computing device like the processing circuitry). The memory device may be configured to store information, data, content, applications, instructions, or the like for enabling the apparatus to carry out various functions in accordance with an example embodiment of the present disclosure. For example, the memory device could be configured to store image data in an image buffer for processing by the processing circuitry. Additionally, or alternatively, the memory device could be configured to store instructions for execution by the processing circuitry, such as instructions associated with generating a video stream, converting image data, and/or the like.

The apparatus 200 may, in some embodiments, be embodied in various computing devices as described above. However, in some embodiments, the apparatus may be embodied as a chip or chip set. In other words, the apparatus may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus may therefore, in some cases, be configured to implement an embodiment of the present invention on a single chip or as a single “system on a chip.” As such, in some cases, a chip or chipset may constitute means for performing one or more operations for providing the functionalities described herein.

The processing circuitry 202 may be embodied in a number of different ways. For example, the processing circuitry may be embodied as one or more of various hardware processing means such as a coprocessor, a microprocessor, a controller, a digital signal processor (DSP), a processing element with or without an accompanying DSP, or various other circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processing circuitry may include one or more processing cores configured to perform independently. A multi-core processing circuitry may enable multiprocessing within a single physical package. Additionally, or alternatively, the processing circuitry may include one or more processors configured in tandem via the bus to enable independent execution of instructions, pipelining and/or multithreading.

In an example embodiment, the processing circuitry 202 may be configured to execute instructions stored in the memory 204 or otherwise accessible to the processing circuitry. Alternatively, or additionally, the processing circuitry may be configured to execute hard coded functionality. As such, whether configured by hardware or software methods, or by a combination thereof, the processing circuitry may represent an entity (e.g., physically embodied in circuitry) capable of performing operations according to an embodiment of the present disclosure while configured accordingly. Thus, for example, when the processing circuitry is embodied as an ASIC, FPGA or the like, the processing circuitry may be specifically configured hardware for conducting the operations described herein. Alternatively, as another example, when the processing circuitry is embodied as an executor of instructions, the instructions may specifically configure the processor to perform the algorithms and/or operations described herein when the instructions are executed. However, in some cases, the processing circuitry may be a processor of a specific device (e.g., an image or video processing system, such as an application server 102) configured to employ an embodiment of the present invention by further configuration of the processing circuitry by instructions for performing the algorithms and/or operations described herein. The processing circuitry may include, among other things, a clock, an arithmetic logic unit (ALU) and logic gates configured to support operation of the processing circuitry.

The communication interface 206 may be any means such as a device or circuitry embodied in either hardware or a combination of hardware and software that is configured to receive and/or transmit data, including media content in the form of video or image files, one or more audio tracks or the like. In an example embodiment, the communication interface 206 may be configured to receive and/or transmit one or more image files associated with a video stream from an application server 102. In this regard, the communication interface may include, for example, an antenna (or multiple antennas), ports, or communications devices and supporting hardware and/or software for enabling communications with a communication network. Additionally, or alternatively, the communication interface may include the circuitry for interacting with the ports and/or antenna(s) to cause transmission of signals via the ports and/or antenna(s) or to handle receipt of signals received via the ports and/or the antenna(s). In some environments, the communication interface may alternatively or also support wired communication. As such, for example, the communication interface may include a communication modem and/or other hardware/software for supporting communication via cable, digital subscriber line (DSL), universal serial bus (USB) or other mechanisms.

In an embodiment in which the apparatus 200 is embodied by an application server 102, the apparatus 200 may comprise additional circuitry for carrying out operations associated with generating a video stream from data in an image buffer. For example, the apparatus 200 may comprise video streaming circuitry 208, graphics processing circuitry 210, and image conversion circuitry 212. The video streaming circuitry 208, graphics processing circuitry 210, and image conversion circuitry 212 may each comprise one or more instructions or predefined functions for directing the processor 202 to carry out operations associated with the respective circuitry. In an embodiment, the video streaming circuitry 208 may comprise one or more predefined functions and/or commands for outputting a live stream to a client device 108. In some embodiments, the graphics processing circuitry 210 may comprise may comprise one or more predefined functions and/or commands for reading data from an image buffer and/or writing data to a shared memory object. In another embodiment, the image conversion circuitry 212 may comprise one or more predefined functions and/or commands for converting image data in a first format to a second format.

In an embodiment, the application server 102 may comprise a graphics application that is executed on the processor 202. The graphics application may be any type of software application configured to generate and/or receive data and store data at a buffer in memory. In an example embodiment, the graphics application executed on the processor 202 of the application server 102 may be configured to store image data in an image buffer in memory 204. In the above avionics simulation example, the graphics application may receive data, such as raw data associated with an aircraft synoptic page, and store the data as image data in an image buffer. In one embodiment, the graphics application may receive data associated with one or more aircraft synoptic pages from a maintenance engineer manually providing the data to the graphics application.

The image buffer may be a block of allocated memory 204 for storing image data associated with the graphics application. In some embodiments, the image buffer may be allocated by the graphics application and/or the application server 102. In this regard, the graphics application and/or application server 102 may be configured to determine one or more addresses in memory 204 at which to store image data associated with the graphics application.

The graphics application may store the image data in the image buffer during an iteration of the graphics application (e.g., while the graphics application is being run by a user, while it is executing a simulation, and/or the like). For example, the graphics application may be configured to store image data in the image buffer during each iteration or at one or more predefined iterations. In this regard, the graphics application may overwrite image data stored in the image buffer from a previous iteration with image data from a current iteration.

In some embodiments, the iterations of the graphics application may be associated with an active simulation being executed on the processor 202 by the graphics application. In the example embodiment described above, data associated with one or more aircraft synoptic pages of a flight may be provided to the graphics application by a maintenance engineer after the flight has concluded. In this regard, the graphics application may convert or otherwise process the data into image data and store the image data in an image buffer.

In some embodiments, image data may comprise data from at least one pixel related to an iteration of the graphics application. Image data may comprise a plurality of data and attributes related to at least one pixel of an image. For example, image data may comprise a value representing the number of pixels in an image, pixel-based width and height values of the image, one or more coordinates associated with a location the at least one pixel within an image, data associated with a data format of the at least one pixel, a data type associated with the at least one pixel, and/or the like.

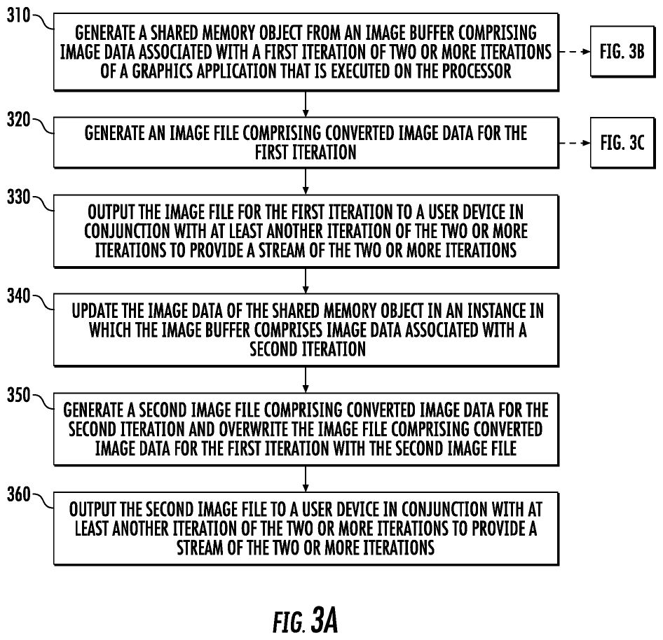

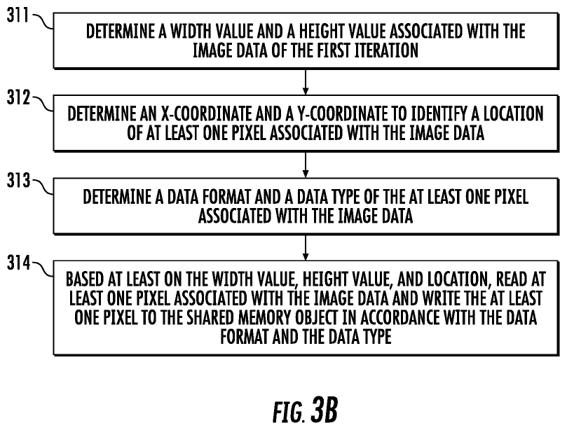

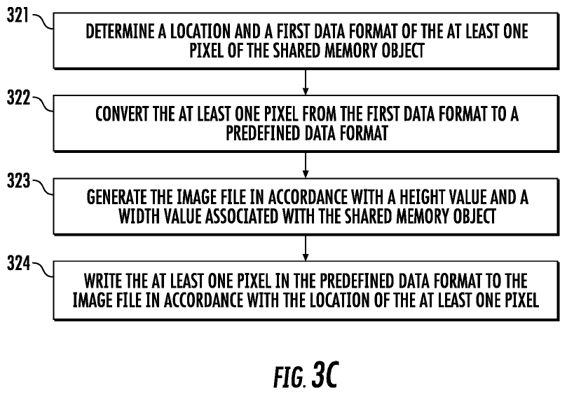

FIG. 3A illustrates operations that may be performed by the application server 102 for generating a video stream from a shared memory object containing image data from an image buffer. At operation 310, the application server 102 may generate a shared memory object from an image buffer comprising image data associated with a first iteration of two or more iterations of a graphics application. In some embodiments, the graphics application is an application that is executed on the processor 202 of the application server 102. In an embodiment, a graphics application may store image data in the image buffer during an iteration of the graphics application. In an embodiment, the image data may comprise data from at least one pixel related to the first iteration.

The image data in the image buffer may then be captured and written to the shared memory object. The shared memory object may comprise a data structure to represent memory that can be mapped concurrently into the address space of more than one process, such as processes carried out by the application server 102, web server 104, processor 202, communication interface 206, or any circuitry associated with the processor, such as video streaming circuitry 208, graphics processing circuitry 210, and/or image conversion circuitry 212. In this regard, the application server 102 includes means, such as the processor 202, graphics processing circuitry 210, or the like, for generating a shared memory object from an image buffer comprising image data associated with a first iteration of two or more iterations of a graphics application that is executed on the processor. For example, the processing circuitry 202 and/or associated circuitry, such as graphics processing circuitry 210, may be configured to generate a shared memory object in the form of a data structure and store the shared memory object in memory 204.

The operations involved in the generation of the shared memory object from the image buffer by the application server 102 are further described with reference to FIG. 3B. For example, the generation of the shared memory object from the image buffer may comprise the application server 102, via graphics processing circuitry 210, accessing image data associated with an iteration of the graphics application within the image buffer in order to determine one or more attributes associated with the image data.

In this regard, at operation 311, the application server 102 includes means, such as the processor 202, graphics processing circuitry 210, or the like, for determining a width value and a height value associated with the image data of the first iteration. In an embodiment, the width value and the height value may be pixel-based, such that the width value comprises a number of pixels representing the width of an image and the height value comprises a number of pixels representing the height of the image. In other embodiments, the application server 102, via graphics processing circuitry 210, may determine a width value and the height value based on additional attributes associated with the image data.

At operation 312, the application server 102 may determine or otherwise rely on an x-coordinate and a y-coordinate of at least one pixel associated with the image data to identify a location of the least one pixel. In this regard, the application server 102 includes means, such as the processor 202, graphics processing circuitry 210, or the like, for determining an x-coordinate and a y-coordinate to identify a location of at least one pixel associated with the image data. In an embodiment, each pixel of the image data in the image buffer associated with an iteration of the graphics application may comprise one or more attributes, such as a set of coordinates, defining a location of the respective pixel within an image. For example, a pixel comprising an x-coordinate attribute of 0 and a y-coordinate attribute of 0 may be indicative of the pixel being located in the bottom left corner of an image. Accordingly, and in some example embodiments, each pixel can be iteratively or simultaneously identified and/or read by its one or more attributes.

At operation 313, the application server 102 may determine a data format and a data type of the at least one pixel associated with the image data. In this regard, the application server 102 includes means, such as the processor 202, graphics processing circuitry 210, or the like, for determining a data format and a data type of the at least one pixel associated with the image data in the image buffer. In some embodiments, the image data may comprise data associated with a data format of at least one pixel of the image data. In some embodiments, the data format of the at least one pixel may be a special format associated with the graphics application. The data format may comprise information related to a color channel (e.g., red-green-blue (RGB) data format, red-green-blue-alpha (RGBA) data format and/or the like) or color space of the at least one pixel and may indicate how the color data is encoded and organized. In some embodiments, the image data may comprise data associated with a data type of at least one pixel of the image data. The data type may be, for example, an integer type, a floating-point type, an unsigned integer type, and/or the like.

At operation 314, the application server 102 may read at least one pixel associated with the image data and write the at least one pixel to the shared memory object in accordance with the determined data format and the data type. In this regard, the application server 102 includes means, such as the processor 202, graphics processing circuitry 210, or the like, for, based at least on the width value, height value, and location, reading at least one pixel associated with the image data and writing the at least one pixel to the shared memory object in accordance with the data format and the data type. The at least one pixel associated with the image data may be written to and stored at the shared memory object for purposes of being shared among multiple processes, such as processes carried out by the application server 102 and associated circuitry, such as video streaming circuitry 208, graphics processing circuitry 210, and/or image conversion circuitry 212. The at least one pixel written to the shared memory object may comprise the determined attribute values, such as the location (e.g., x and y coordinate values), the data type, the data format, the pixel-based width value and pixel-based height value, and/or the like.

In some examples, the steps of 312-314 may be iteratively or simultaneously performed until all or substantially all of the pixels identified at least based on the width value and the height value have be identified and/or read out into the shared memory object.

Returning to FIG. 3A, at operation 320, the application server 102 may generate an image file comprising converted image data. In an embodiment, the converted image data is generated based on a conversion of the pixel data in a first data format stored in the shared memory object to converted image data in a second data format. In some embodiments, the first data format may comprise a data format in which the at least one pixel was formatted in at the time it was written to the shared memory object.

The operations involved in generating the image file comprising converted image data for the first iteration by the application server 102 are further described with reference to FIG. 3C. At operation 321, the application server 102 may determine a location and a first data format of the at least one pixel of the shared memory object. In this regard, the application server 102 includes means, such as the processor 202, image conversion circuitry 212, or the like, for determining a location and a first data format of the at least one pixel of the shared memory object. In an example embodiment, the application server 102, via image conversion circuitry 212, may access the shared memory object to retrieve the at least one pixel and determine the location and the first data format of the at least one pixel of the shared memory object. The location of the at least one pixel may be based on data associated with an x-coordinate and a y-coordinate of the at least one pixel associated with the image data stored in the shared memory object.

At operation 322, the application server 102 may convert the at least one pixel from the first data format to a second data format. For example, the second data format may be an image format suitable for inclusion in a video stream, such as a Joint Photographic Experts Group (JPEG) format, Portable Network Graphics (PNG) format, bitmap (BMP) image format, Graphics Interchange Format (GIF), and/or the like. In this regard, the application server 102 includes means, such as the processor 202, image conversion circuitry 212, or the like, for converting the at least one pixel from the first data format to a second data format. In this regard, the image conversion circuitry 212 may comprise one or more predefined functions and/or commands for converting the at least one pixel from the first data format to a second data format, such as functions and/or commands for converting a color space of the at least one pixel to a second color space associated with the second data format.

At operation 323, the application server 102 may generate an image file in accordance with a height value and a width value associated with the shared memory object. For example, the application server 102 and/or image conversion circuitry 212 may generate an image file, such as a JPEG file or PNG file, in accordance with the pixel-based height value and pixel-based width value of the at least one pixel stored in the shared memory object. In this regard, the image file may be prepared in accordance with the size of the image associated with the at least one pixel. In an embodiment, the application server may temporarily store the image file, such as in memory 204, prior to writing the at least one pixel to the image file.

At operation 324, the application server 102 may write the at least one pixel in the second data format to the image file in accordance with the location of the at least one pixel. In this regard, the application server 102 includes means, such as the processor 202, image conversion circuitry 212, or the like, for writing the at least one pixel in the second data format to the image file in accordance with the location of the at least one pixel. In an embodiment, the at least one pixel in the second data format may be written to the image file in accordance with a quality level and/or a compression level. In a case in which the image file is a JPEG file, the image conversion circuitry 212 may determine a quality level associated with the JPEG file. In a case in which the image file is a PNG file, the image conversion circuitry 212 may determine a compression level associated with the PNG file. In some example embodiments, the image conversion circuitry 212 may comprise additional functions and/or commands for rotating, flipping, and/or resizing the image file. Once each pixel is written to the image file, the image file may be output to a user device in a stream.

Returning to FIG. 3A, at operation 330, the application server 102 may output the image file for the first iteration to a user device in conjunction with at least another iteration of the two or more iterations to provide a stream of the two or more iterations. In this regard, the application server 102 includes means, such as the processor 202, video streaming circuitry 208, or the like, for outputting the image file for the first iteration to a user device in conjunction with at least another iteration of the two or more iterations to provide a stream of the two or more iterations.

In an embodiment, the video streaming circuitry 208 may comprise one or more predefined functions and/or commands for outputting a live stream to a client device 108. For example, the video streaming circuitry 208 may be configured to access the generated image file comprising the at least one pixel from memory 204. The video streaming circuitry 208 may use data associated with the generated image file in order to generate and output a live stream of the image file. For example, the video streaming circuitry 208 may determine a file path associated with the image file and pass the file path as a parameter to a function and/or command for outputting a live stream to a client device 108. The video streaming circuitry 208 may determine additional parameters such as a bitrate associated with the live video stream to be output, a chunk size of segments associated with the live stream, a streaming format, a resolution of the live stream, and/or the like. In this regard, the application server 102 includes means, such as the processor 202, video streaming circuitry 208, or the like, for encoding the video stream in a predefined format and encrypting the video stream in a predefined format.

In some embodiments, the application server 102 may provide, via communication interface 206, the image file at a given file path for the first iteration and the one or more determined parameters to a web server 104 over a network 106 for streaming to a user device 108. For example, the web server 104 may comprise circuitry to generate a playable uniform resource locator (URL) for a stream comprising the image file such that the stream may be viewed on a user device upon accessing the URL at the user device. The web server 104 may comprise circuitry to authenticate and authorize users and/or client devices accessing the live stream and provide additional security against penetration attacks and/or the like.

In an embodiment, at operation 340, the application server 102 may update the image data of the shared memory object. The image data of the shared memory object may be updated in an instance in which the image buffer comprises image data associated with a second iteration. For example, the application server 102 may be configured to monitor the image buffer in order to determine an instance in which the image buffer is updated with new image data by the graphics application. In this regard, the application server includes means, such as the processor 202, graphics processing circuitry 210, or the like, for updating the image data of the shared memory object in an instance in which the image buffer comprises image data associated with a second iteration. In some example embodiments, updating the image data of the shared memory object comprises overwriting the image data associated with a first iteration of the shared memory object with image data associated with a second iteration.

Once it has been detected or otherwise determined that the shared memory object has been updated with the image data associated with the second iteration, at operation 350, the application server 102 may generate a second image file comprising converted image data for the second iteration and overwrite the image file comprising converted image data for the first iteration with the second image file. The conversion of the image data for the second iteration may be similar to the steps described above in regard to conversion of the image data for the first iteration.

At operation 360, the application server 102 may output the second image file to a user device in conjunction with at least another iteration of the two or more iterations to provide a stream of the two or more iterations. In this regard, the live streamed image a user is viewing at a client device 108 may change in an instance in which the second image file is outputted to the user device. For example, the video streaming circuitry 208 may continue to output a live video stream to the client device 108 based on the file path associated with the image file and the second image and pass the file path as a parameter to a function and/or command for outputting a live video stream to the client device 108. As the image file is overwritten (e.g., the image file is overwritten by the second image file), the same file path to the image file is used as a parameter for outputting a live video stream, thus the live video stream may be generated from the image file as the content of the image file changes dynamically.

As described above, a method, apparatus, and computer program product are disclosed for generating a video stream from a shared memory object containing image data from an image buffer. By providing for streaming of displays associated with a graphics application using an image buffer as input source, a real-time, light-weight, and secure solution to live video streaming is provided.

FIGS. 3A-3C illustrate flowcharts depicting methods according to an example embodiment of the present invention. It will be understood that each block of the flowcharts and combination of blocks in the flowcharts may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by a memory device 204 of an apparatus employing an embodiment of the present invention and executed by a processor 202. As will be appreciated, any such computer program instructions may be loaded onto a computer or other programmable apparatus (for example, hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowcharts support combinations of means for performing the specified functions and combinations of operations for performing the specified functions for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims.

Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. An apparatus configured to generate a video stream, the apparatus comprising
at least one processor and at least one non-transitory memory including program code, the at least one non-transitory memory and the program code configured to, with the processor, cause the apparatus to at least:
generate a shared memory object from an image buffer comprising image data associated with a first iteration of two or more iterations of a graphics application, wherein the image data comprises pixel data from at least one pixel related to the first iteration;
generate converted image data based on a conversion of the pixel data in a first data format to converted image data in a second data format;
generate an image file comprising the converted image data for the first iteration; and
output the image file for the first iteration to a user device in conjunction with at least another image file from another iteration of the two or more iterations to provide a video stream of the two or more iterations.

2. An apparatus according to claim 1, wherein the memory including the program code is further configured to, with the processor, cause the apparatus to:
update the shared memory object in an instance in which the image buffer comprises image data associated with a second iteration, wherein the shared memory object comprises the image data associated with the second iteration;
generate converted image data for the second iteration;
generate a second image file comprising the converted image data for the second iteration based on converted image data for the second iteration, wherein the second image file overwrites the image file comprising converted image data for the first iteration; and
output the second image file to a user device in conjunction with the first iteration.

3. An apparatus according to claim 1, wherein the at least one non-transitory memory and the program code that is configured to, with the processor, cause the apparatus to at least generate the shared memory object from the image buffer is further configured to:
determine a width value and a height value associated with the image data of the first iteration;
determine an x-coordinate and a y-coordinate to identify a location of at least one pixel within the image data;
determine a data format and a data type of the at least one pixel associated with the image data; and
based at least on the width value, height value, and location, read at least one pixel associated with the image data and write the at least one pixel to the shared memory object in accordance with the data format and the data type.

4. An apparatus according to claim 1, wherein the at least one non-transitory memory and the program code that is configured to, with the processor, cause the apparatus to at least generate the image file comprising the converted image data is further configured to:
determine a location and a first data format of the at least one pixel of the shared memory object; and
write the at least one pixel in the second data format to the image file in accordance with the location.

5. An apparatus according to claim 1, wherein the at least one non-transitory memory and the program code is further configured to, with the processor, cause the apparatus to at least update the image data in the image buffer by the graphics application.

6. An apparatus according to 1, wherein the at least one non-transitory memory and the program code that is configured to, with the processor, cause the apparatus to at least provide a video stream of the two or more iterations is further configured to:
encode the video stream in a predefined format; and
encrypt the video stream in a predefined format.

7. A computer-implemented method for generating a video stream, the computer-implemented method comprising:
generating a shared memory object from an image buffer comprising image data associated with a first iteration of two or more iterations of a graphics application, wherein the image data comprises pixel data from at least one pixel related to the first iteration;
generating converted image data based on a conversion of the pixel data in a first data format to converted image data in a second data format;
generating an image file comprising the converted image data for the first iteration; and
outputting the image file for the first iteration to a user device in conjunction with at least another image file from another iteration of the two or more iterations to provide a video stream of the two or more iterations.

8. A computer-implemented method according to claim 7, further comprising:
updating the shared memory object in an instance in which the image buffer comprises image data associated with a second iteration, wherein the shared memory object comprises the image data associated with the second iteration;
generating converted image data for the second iteration;
generating a second image file comprising the converted image data for the second iteration based on converted image data for the second iteration, wherein the second image file overwrites the image file comprising converted image data for the first iteration; and
outputting the second image file to a user device in conjunction with the first iteration.

9. A computer-implemented method according to claim 7, wherein generating the shared memory object from the image buffer comprises:
determining a width value and a height value associated with the image data of the first iteration;
determining an x-coordinate and a y-coordinate to identify a location of at least one pixel within the image data;
determining a data format and a data type of the at least one pixel associated with the image data; and
based at least on the width value, height value, and location, reading at least one pixel associated with the image data and writing the at least one pixel to the shared memory object in accordance with the data format and the data type.

10. A computer-implemented method according to claim 7, wherein generating the image file comprising the converted image data for the first iteration comprises:
determining a location and the first data format of the at least one pixel of the shared memory object; and
writing the at least one pixel in the second data format to the image file in accordance with the location.

11. A computer-implemented method according to claim 7, wherein the image data is updated in the image buffer by the graphics application.

12. A computer-implemented method according to claim 7, wherein providing a video stream of the two or more iterations comprises:
encoding the video stream in a predefined format; and
encrypting the video stream in a predefined format.

13. A computer program product comprising at least one non-transitory computer-readable storage medium having computer-readable program code portions stored therein, the computer-readable program code portions comprising an executable portion configured to:
generate a shared memory object from an image buffer comprising image data associated with a first iteration of two or more iterations of a graphics application, wherein the image data comprises data from at least one pixel related to the first iteration;
generate converted image data based on a conversion of the pixel data in a first data format to converted image data in a second data format;
generate an image file comprising the converted image data for the first iteration; and
output the image file for the first iteration to a user device in conjunction with at least another image file from another iteration of the two or more iterations to provide a video stream of the two or more iterations.

14. A computer program product according to claim 13, wherein the computer-readable program code portions comprising the executable portion are configured to further:
update the shared memory object in an instance in which the image buffer comprises image data associated with a second iteration, wherein the shared memory object comprises the image data associated with the second iteration;
generate converted image data for the second iteration;
generate a second image file comprising converted image data for the second iteration based on converted image data for the second iteration, wherein the second image file overwrites the image file comprising converted image data for the first iteration; and
output the second image file to a user device in conjunction with the first iteration.

15. A computer program product according to claim 13, wherein the computer-readable program code portions comprising an executable portion configured to generate the shared memory object from the image buffer is further configured to:
determine a width value and a height value associated with the image data of the first iteration;
determine an x-coordinate and a y-coordinate to identify a location of at least one pixel associated with the image data;
determining a data format and a data type of the at least one pixel associated with the image data; and
based at least on the width value, height value, and location, reading at least one pixel associated with the image data and write the at least one pixel to the shared memory object in accordance with the data format and the data type.

16. A computer program product according to claim 13, wherein the computer-readable program code portions comprising an executable portion configured to generate the image file comprising converted image data for the first iteration is further configured to:
determine a location and a first data format of the at least one pixel of the shared memory object; and
write the at least one pixel in the second data format to the image file in accordance with the location.

17. A computer program product according to claim 13, wherein the computer-readable program code portions comprising the executable portion are further configured to at least update the image data in the image buffer by the graphics application.

18. A computer program product according to 13, wherein the computer-readable program code portions comprising an executable portion configured to provide a video stream of the two or more iterations is further configured to:
encode the video stream in a predefined format; and
encrypt the video stream in a predefined format.
